(19) United States
(12) Patent Application Publication
(10) Pub. No.: US 2009/0021192 A1
(43) Pub. Date: Jan. 22, 2009

(54) Switched Reluctance Machine And Method Of Operation Thereof

(76) Inventor: Srinivas Kudligi, Bangalore (IN)

Correspondence Address: LAWRENCE Y.D. HO & ASSOCIATES PTE LTD, 30 BIDEFORD ROAD, #02-02, THONGSIA BUILDING, SINGAPORE, 229922, SG

(21) Appl. No.: 11/910,743

(22) PCT Filed: Apr. 6, 2006
(86) PCT No.: PCT/IN06/00119

§ 371 Date: Feb. 26, 2008

(30) Foreign Application Priority Data
Apr. 8, 2005 (IN) 398/CHE/2005

(51) Int. Cl. H02P 25/08

(52) U.S. Cl. 318/254.1

(57) ABSTRACT

The present invention provides an S SRM (switched reluctance machine), which supports one or more phases and each phase comprises a stator, a rotor and coils. The stator is hollow, cylindrical and comprises stator poles extending inwards, such that a recess is formed between adjacent stator poles. The coils are wound on the stator poles and occupy the recess. The rotor is positioned inside the stator and has poles extending outwards. The rotor and stator poles subtend an angle having a maximum value of 0.5 electrical pole pitches at a center of rotation. The different phases are distributed along the axis of the S SRM. The rotor is rotated by a reluctance torque generated by energizing a phase in a current controlled manner until the rotor rotates through a minimum commutation angle required to maintain motion; de-energizing the phase by freewheeling it by using the energy stored in it and simultaneously energizing a second sequentially adjacent phase.

### FIELD OF INVENTION

The present invention relates to a switched reluctance machine that can be operated either as a motor or a generator. More particularly, the present invention relates to a switched reluctance machine, which supports a higher angle of commutation than the minimum required angle, and generates positive torque by freewheeling a phase during the motion of the machine through the angle which is in excess of the minimum required commutation angle.

### BACKGROUND OF THE INVENTION

A Switched Reluctance (SR) motor is a rotating electrical machine where both the stator and the rotor have salient poles. The stator winding comprises a set of coils, each of which is wound on one stator pole. SR motors have a certain number of suitable combinations of stator and rotor poles.

FIG. 1 illustrates a conventional SR motor 100. The SR motor 100 has six stator poles S1 to S6 and four rotor poles R1 to R4. θS indicates the angle subtended by a stator pole at a center of rotation and θR indicates the angle subtended by a rotor pole at the center of rotation. θC indicates the angle through which the rotor pole R2 and R4 rotate for alignment when coils representing a phase, wound around the poles S2 and S5 are energized. θC is termed as a commutation angle. A commutation angle is an angle through which a particular phase, wound on a stator pole, when energized brings a rotor pole into alignment with a stator pole of the phase.

Conventionally, the number of commutations per rotation, in an SR machine, is given by:

NS×NR/(NS−NR) (1)

where: NS and NR denote number of stator and rotor poles respectively.

Therefore, the number of commutations per rotation for the SR machine 100 is twelve. Consequently, each commutation accounts for 360/12=30 degrees of motion.

Therefore, θC=30 degrees.

Conventionally,

θS=θR=θC=360/NS×NR/(NS−NR) (2)

Equation (2) applies to the SR motor 100 as, θC=30 degrees is the minimum required commutation angle required to maintain motion.

During the operation of the SR motor 100, in order to derive clockwise motion, the aligned position of the poles S1 and R1 is sensed and the coils around the poles S3 and S6 are energized. At this point in operation the inductance is the least (least aligned position) and hence the energy stored is also the least i.e., zero. As the rotor rotates in the clockwise direction to bring the poles R2 and S3 in alignment, the inductance increases as also the energy stored. The inductance and the energy stored reach a maximum value when R2 and S3 are aligned. At this point the coils around the poles S3 and S6 are de-energized and the coils around the poles S2 and S5 are energized, thereby resulting in a clockwise motion of the rotor. The entire sequence is repeated for the sequentially adjacent phase in order to obtain continuous motion.

The phase voltage relationship in a switched reluctance motor is represented by the equation:

$$V = iR + \frac{d λ}{d t} . \qquad ( 3 )$$

where, V is the dc bus voltage, ‘i’ is the instantaneous phase current, R is the phase winding resistance and λ is the flux linking the phase coil. Ignoring stator resistance, Equation 3 is also represented as:

$$V = L ( θ ) \frac{d i}{d t} + i \frac{d L ( θ )}{d ( θ )} ω \qquad ( 4 )$$

where, ω is the rotor speed, θ is the rotor angular position, and L(θ) is the instantaneous phase inductance. The rate of flow of energy is obtained by multiplying the voltage with current and is represented as:

$$\begin{matrix}V = Li \frac{d i}{d t} + {i}^{2} \frac{d L}{d θ} ω \\ Or , & ( 5 ) \\ P = \frac{d}{d t} ( \frac{1}{2} {Li}^{2} ) + \frac{1}{2} {i}^{2} \frac{d L}{d θ} ω & ( 6 )\end{matrix}$$

The first term

$$( \frac{d}{d t} ( \frac{1}{2} {Li}^{2} ) )$$

of Equation 6 represents rate of increase in the stored magnetic field energy while the second term

$$( \frac{1}{2} {i}^{2} \frac{d L}{d θ} ω )$$

represents mechanical output. Therefore, the instantaneous torque is represented as:

$$T ( θ , i ) = \frac{1}{2} {i}^{2} \frac{d L}{d θ} \qquad ( 7 )$$

Equation 7 represents the relationship between the torque, current, inductance and rotor angular position. If the current is maintained at a constant value then the torque generated is dependant on the slope of inductance with respect to the rotor angular position.

Based on equations 3-7, the inductance is the least at the start of the commutation and attains a maximum value at the filly aligned position of a rotor pole with a phase. In a conventional SR motor, the energy stored at the end of commutation has to be drained before the fully aligned position of a rotor pole with respect to a phase is reached. Else by virtue of the energy stored, and the reversal in dL/dθ (rate of change of inductance with respect to rate of change in the rotor angular position) a negative torque is developed. Hence, active methods of draining the energy and using it to charge a desired phase are used. A need may be felt for an SR machine where there is no requirement for actively draining out the energy stored in an off going phase.

Conventionally, there are two switching requirements for an SR machine. One being, the switching (turning on or off) of input voltage and hence input current for carrying out current regulation. Second being, the commutation switching based on a commutation position being reached. These two switching are based on different criteria. Therefore, a minimum of one switch per phase and one common switch is employed in the conventional SRM for fulfilling the two switching requirements. Since, there is a need for two switches to be used one switch is employed on a top-side and the other on a bottom side of a control circuit, as in a typical asymmetric half bridge circuit configuration.

Since, conventional SR machines are operated using a current control circuitry, when the current in a phase winding has reached a predefined value the phase is turned off for performing current regulation. The turned off phase is maintained in a freewheeling mode till the predefined lower value of current is reached. The topside switch, which is a common current regulating switch for the phases, accomplishes this. Therefore, the current regulating switching is performed using the topside switch of the control circuit.

Generally an IGBT or MOSFET switch is employed in the control circuits for SR machines. When an IGBT or MOSFET is employed as the topside switch, the gate of the switch needs to be provided with a voltage that is precisely 12-15 Volts higher than a transient high side voltage. This is accomplished by using a bootstrap or a charge pump circuit. The bootstrap circuit configuration requires certain reactive components that have to be selected based on specific operating conditions. This circuit configuration works well for pulse width modulation strategy that is adopted for the other forms of motors such as brushless DC motors. However, in SR machines, since a current control strategy is preferred, the topside switch must remain turned on as long as a predefined current is not reached. This time period is variable and depends on the operating conditions. Therefore, it is difficult to use the topside switch in SR machine control circuits. This problem does not exist for a low side switch. Alternately, the desired current characteristics could be maintained by using the Pulse Width Modulation (PWM) technique. In this technique also there is a need for a switch on the topside and one at the lower side of the control circuitry, as in the typical half bridge configuration. Therefore, a need may be felt for an SR motor that can be controlled by a single switch, thereby eliminating the requirement of a topside switch in the control circuit of the machine.

Conventionally, the coils of a phase of an SR motor are distributed around the axis of the motor, which is also the rotor and stator axis. These coils are wound around the poles of the stator and occupy the space therebetween. If the θC is maintained by design at a value higher than the minimum required value as indicated by equation (2), the space available for the coils is reduced. Therefore, there is need for an SR motor, which, by virtue of its construction leads to better space utilization.

Hence a need may be felt for an improved SR machine including SR motor and SR generator, which is efficient, reliable and provides a distinct cost advantage by reducing the number of circuit elements.

### SUMMARY OF THE INVENTION

The present invention provides an S SRM (switched reluctance machine), which supports a higher angle of commutation than the minimum required angle, and generates positive torque by freewheeling a phase during the motion of the machine through the angle which is in excess of the minimum required commutation angle.

It is an objective of the present invention to provide an S SRM in which the generation of negative torque by an off-going phase is eliminated/reduced.

It is another objective of the present invention to provide an S SRM in which productive use of the energy of an off-going phase is made by freewheeling the phase while it generates positive torque.

It is yet another objective of the present invention to provide an S SRM, which generates torque with reduced torque ripple.

It is still another objective of the present invention to provide an S SRM in which, a single switch performs both current regulation switching and commutation switching, in a motoring mode.

It is still another objective of the present invention to provide an S SRM in which a switch may be positioned on a low side of a control circuit for the S SRM, thus eliminating topside switching problems in a motoring mode.

It is yet another objective of the present invention to provide an S SRM with an increased coil winding space, thereby reducing resistance of the coil windings.

It is still another objective of the present invention to provide an S SRM, which generates high torque densities and high power densities, and has the advantages of being simple, robust, reliable, efficient, producing less noise and being obtainable at a low cost.

To meet the above mentioned and other objectives, the present invention provides switched reluctance (SR) machine supporting a plurality of phases distributed along the axis of rotation. Each phase whereof comprises a hollow and substantially cylindrical stator having a plurality of inwardly extending stator poles positioned substantially equidistant from each other, two adjacent stator poles defining a recess therebetween; a substantially cylindrical rotor positioned in the stator and having a plurality of outwardly extending rotor poles formed on the outer surface thereof, each of the stator pole and the rotor pole subtending an angle having a value less than 0.5 electrical pole pitches at the center of rotation; a means for supporting the rotor for rotation about the axis; coils provided on stator poles in proportion to the number of the poles and wound thereon, the coils occupying the recess between adjacent stator poles.

The rotor is rotated in a desired direction by a reluctance torque, which is generated between the rotor and the stator by energizing a phase in a current controlled manner. The current regulation is achieved either by Hysterisis regulation or by using the Pulse Width Modulation (PWM) technique. The energizing is concluded upon the rotation of the rotor through a minimum commutation angle required to maintain motion. Next the phase is switched off and de-energized by freewheeling the phase, a freewheeling current being maintained by energy stored in the phase. Next, a second sequential phase energized. The steps of switching off the phase and energizing a second sequential phase are performed substantially simultaneously.

The present invention also provides, a method of operating a switched reluctance (SR) machine supporting one or more phases distributed along the axis of rotation. Each phase whereof comprises a hollow and substantially cylindrical stator having a plurality of inwardly extending stator poles positioned substantially equidistant from each other, two adjacent stator poles defining a recess therebetween; a substantially cylindrical rotor positioned in the stator and having a plurality of outwardly extending rotor poles formed on the outer surface thereof, each of the stator pole and the rotor pole subtending an angle having a value less than 0.5 electrical pole pitches at the center of rotation; a means for supporting the rotor for rotation about the axis; coils provided on stator poles in proportion to the number of the poles and wound thereon, the coils occupying the recess between adjacent stator poles. The method comprises the step of rotating the rotor in a desired direction of motion by a reluctance torque generated between the rotor and the stator. The reluctance torque is generated by continuously and repeatedly performing the following steps: Firstly a first phase is energized in a current controlled manner for a first period of time. The first period of time is a time in which the rotor rotates through a minimum commutation angle required for maintaining motion. Next, the phase switched off and is de-energized by freewheeling the phase. A freewheeling current is maintained by energy stored in the phase. Next, a second sequential phase is energized. The steps of switching off the phase and energizing a second sequential phase are performed substantially simultaneously.

### BRIEF DESCRIPTION OF THE ACCOMPANYING DRAWINGS

The present invention is described by way of embodiments illustrated in the accompanying drawings wherein:

FIG. 1 illustrates an exemplary conventional three phase SR motor having a 6/4 configuration;

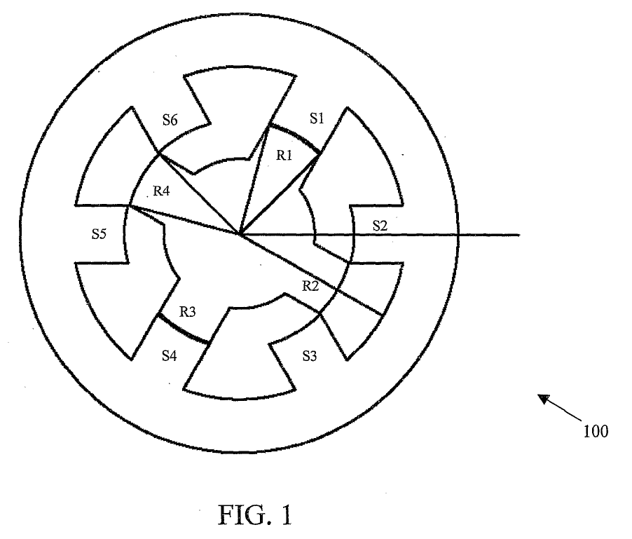

FIGS. 2A and 2B illustrate a three phase S SRM (switched reluctance machine) and a transverse view of the same respectively, in accordance with one embodiment of the present invention;

FIG. 3 illustrates a stator corresponding to a phase of the S SRM, in accordance with one embodiment of the present invention;

FIG. 4 illustrates a rotor corresponding to a phase of the S SRM, in accordance with one embodiment of the present invention;

FIGS. 5A and 5B illustrate coils corresponding to a phase mounted on the stator poles of the S SRM and a side view of the same respectively, in accordance with one embodiment of the present invention;

FIGS. 6A and 6B illustrate a phase of the S SRM and a side view of the same respectively, in accordance with one embodiment of the present invention;

FIG. 7 illustrates the flux loops formed between a rotor and a stator corresponding to a phase of the S SRM, in accordance with one embodiment of the present invention;

FIG. 8 illustrates an alignment of a rotor and a stator pole corresponding to a phase, at the start of commutation for clockwise rotation of the rotor of an S SRM having two rotor and stator poles, in accordance with another exemplary embodiment of the present invention;

FIG. 9 illustrates an alignment of a rotor and a stator at the start of commutation for counterclockwise rotation of the rotor of the S SRM, in accordance with the first embodiment of the present invention;

FIG. 10 illustrates an alignment of a rotor and a stator at the end of commutation for counterclockwise rotation of the rotor of the S SRM, in accordance with the first embodiment of the present invention;

FIG. 11 illustrates a fully aligned position of a rotor and a stator of the S SRM, in accordance with the first embodiment of the present invention;

FIG. 12 illustrates a control circuit for a three phase S SRM being operated as a generator, in accordance with an exemplary embodiment of the present invention; and

FIG. 13 illustrates an embodiment of a control circuit of a four phase S SRM performing a motoring operation.

### DETAILED DESCRIPTION OF THE INVENTION

The present invention would now be discussed in context of embodiments as illustrated in the accompanying drawings.

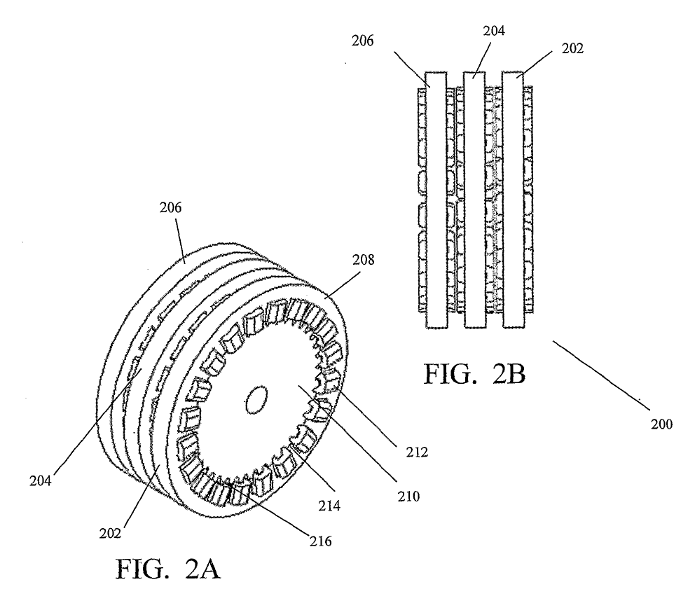

FIG. 2A illustrates a three phase S SRM (switched reluctance machine) 200 and FIG. 2B is a transverse view thereof. Each of the three phases 202, 204 and 206 are distributed along the axis of the S SRM 200, and comprise a stator 208, a rotor 210, and coils 212. The S SRM may be a motor or a generator and such would be apparent to a person having ordinary skill in the art.

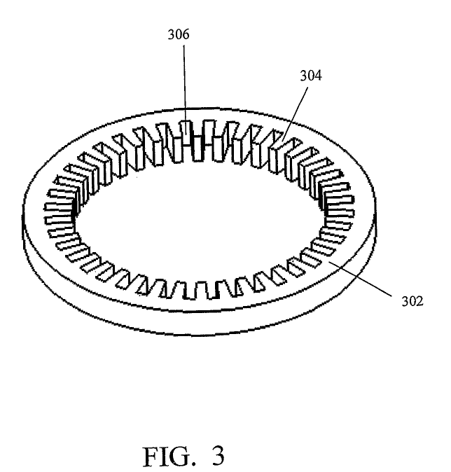

The stator 208 comprises a plurality of stator poles 214 (stator poles 214 are illustrated more clearly as feature 304 in FIG. 3) extending radially inwards from an inner surface thereof. The stator poles 214 are arranged substantially equidistant along an inner circumference of the stator 208, such that a recess is formed between adjacent stator poles 214. The tips of the stator poles 214 are substantially circular and concave.

The rotor 210 is positioned inside the cylindrical cavity formed by stator 208 and stator poles 214 and has a plurality of rotor poles 216 extending radially outwards from an outer surface thereof. Each rotor pole 216 has a substantially circular convex tip. In an embodiment of the present invention, the number of stator poles 214 is equal to the number of rotor poles 216. In other embodiments the number of stator and rotor poles may differ.

The stator 208 and the rotor 210 are concentric for rotation of the rotor 210 about a common axis. The stator poles 214 and the rotor poles 216 subtend a spread angle at a center of rotation, which is also the center of the rotor 210.

The spread angle is approximately equal to:

(360°/(2·N_{Pole}))−θ_{relief} (8)

where: N_{Pole} is the number of poles of the stator or the rotor and θ_{relief} is a relief angle.

The value of the relief angle ranges between:

0≦θrelief≦(360°/(2·N_{Pole}))−(360°/(N_{Phase}·N_{Pole})) (9)

where N_{Phase} is the number of phases supported by the S SRM 200. The spread angle subtended by the stator poles 214 and the rotor poles 216 at the center of rotation has a maximum value of 0.5 electrical pole pitches. In an embodiment of the present invention, the value of the spread angle ranges between 0.33 and 0.49 electrical pole pitch.

Coils 212 corresponding to a phase of the S SRM are mounted on every alternate stator pole 214. Coils 212 are wound around stator poles 214 in such a manner that they occupy the recess between adjacent stator poles 214. As is apparent to a person having ordinary skill in the art, the stator and the rotor may be constructed from laminations and/or sintered materials.

FIG. 3 illustrates a stator 302 for a phase of the S SRM. Stator 302 is hollow and substantially cylindrical in shape and has a plurality of inwardly extending stator poles 304. Stator poles 304 have a substantially concave tip and are positioned substantially equidistant from each other. There is a recess 306 formed between two adjacent stator poles 304. Each stator pole 304 subtends a spread angle having a value less than 0.5 electrical pole pitches at the center of rotation of the S SRM.

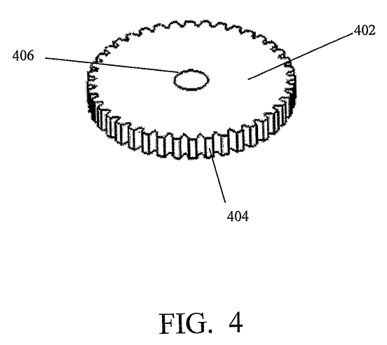

FIG. 4 illustrates a rotor for a phase of the S SRM. Rotor 402 is substantially cylindrical in shape and is positioned within the hollow cylindrical cavity of the stator 302. Rotor 402 has a plurality of outwardly extending rotor poles 404 formed on its outer surface and each of the rotor poles 404 subtend a spread angle having a value less than 0.5 electrical pole pitches at the center of rotation. Rotor 404 has a bore 406 through its center for housing therein a means for supporting the rotor for rotation about the axis, such as an axle or a shaft.

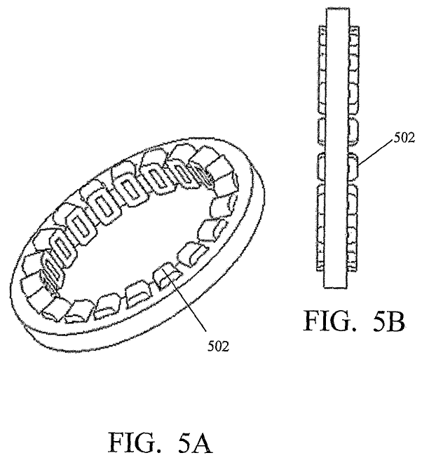

FIG. 5A illustrates coils 502 corresponding to a phase mounted on the stator poles of the S SRM and FIG. 5B is a transverse view thereof, in accordance with one embodiment of the present invention. In various embodiments, the number of coils corresponding to a phase are either equal to or half the number of stator poles. FIGS. 5A and 5B illustrate coils 502 wound around alternate stator poles, and occupying the recess between adjacent stator poles.

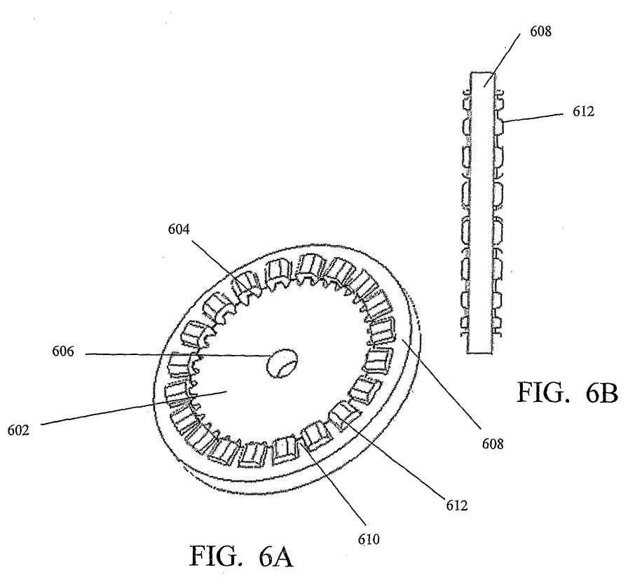

FIG. 6A illustrates a phase of the S SRM and FIG. 6B is a side view thereof. Rotor 602 having rotor poles 604 and bore 606 is positioned within the hollow cylindrical cavity of stator 608. Stator 608 has stator poles 610 which are equal in number to rotor poles 604. In one embodiment of the present invention, coils 612 corresponding to a phase of the S SRM are wound around alternate stator poles 610 and occupy the recess between adjacent stator poles 610. In another embodiment, the coils may be mounted on every one of the stator poles 610. When the coils are mounted on every one of the stator poles, direction of current flowing through coils on adjacent stator poles is opposite to each other, whereas when the coils are mounted on alternate stator poles, direction of current flowing through coils on alternate stator poles is similar, as is apparent to a person skilled in the art.

The operation of the S SRM 200 illustrated in FIG. 2 is described herein. In an embodiment of the present invention the S SRM 200 is operated as a motor. The rotor 210 is rotated by a reluctance torque generated between the rotor 210 and the stator 208. The reluctance torque is generated by energizing a phase (202, 204 or 206) in a current controlled manner. The energizing is stopped when the rotor 210 rotates through a minimum commutation angle required to maintain motion. Next, the phase is switched off and is de-energized by freewheeling the phase. A freewheeling current is maintained by the energy stored in the phase. In addition, a second sequentially adjacent phase, corresponding to a desired direction of rotation, is energized. The steps of de-energizing the first phase and energizing the second sequentially adjacent phase are performed approximately simultaneously. In other embodiments of the present invention, the current regulation of the phase could be carried out by using Pulse Width Modulation (PWM) technique.

In various embodiments of the present invention, a position for commutation is sensed using a variety of sensors such as optical sensors, inductive sensors, capacitive sensors and Hall Effect sensors. In other embodiments of the present invention, a position for commutation may be sensed by using sensor-less methods of the kind that are commonly known in art.

In an embodiment of the present invention, the phases (202, 204 and 206) of the, S SRM 200 are distributed along the axis and the stator corresponding to each phase is rotated by an angle corresponding to (pole pitch)/(no of phases) in mechanical degrees. In another embodiment, the phases (202, 204 and 206) are distributed along the axis at identical angular orientation and the corresponding rotors are mounted on the shaft displaced by an angle corresponding to (pole pitch)/(no of phases) in mechanical degrees.

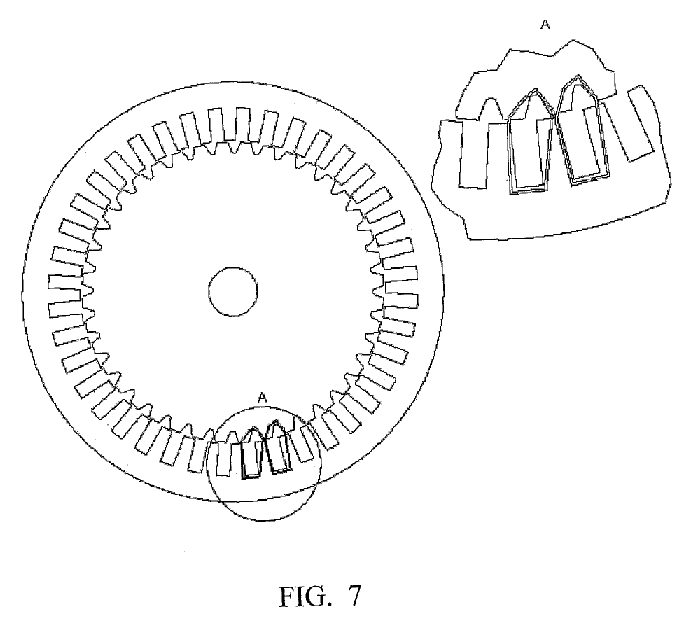

FIG. 7 illustrates typical flux loops 702 formed between a stator and rotor pole, corresponding to a phase of the S SRM and caused by one coil of the phase, in accordance with one embodiment of the present invention.

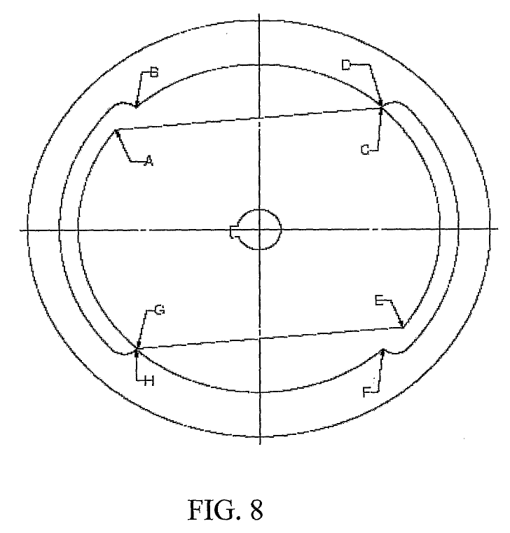

The operation of the S SRM as a motor is described in detail with reference to FIGS. 8-11. FIG. 8 illustrates an alignment of a rotor and a stator pole corresponding to a phase, at the start of commutation for clockwise rotation of the rotor of an S SRM having two rotor and stator poles, in accordance with an exemplary embodiment of the present invention.

The minimum required commutation angle for the S SRM of the present invention is given by:

θ_{Cm}=360/N_{Phase}/N_{Pole} (in mechanical degrees) (10)

or,

θ_{Ce}=360/N_{Phase} (in electrical degrees) (11)

where N_{Phase} and N_{Pole} denote number of phases and number of poles respectively.

Therefore for a four phase, two pole S SRM the minimum required commutation angle θ_{Cm}, to be supported is 360/4/2 which is equal to 45 mechanical degrees or 360/4 which is equal to 90 electrical degrees. Therefore 45 mechanical degrees or 90 electrical degrees represents a first angle corresponding to a minimum commutation angle required to maintain motion.

The minimum value of the spread angle of the rotor θ_{R} and the spread angle of the stator θ_{S} is θ_{Cm}. The maximum value is limited by the condition that the flux links only through points C, D and G, H as illustrated in FIG. 8. Therefore, it is required that the gap between points A, B and E, F are higher than the gap between points C, D and G, H. Consequently, the maximum commutation angle that can be supported θ_{Cm} is a little less than 90 mechanical degrees or 180 electrical degrees. In an embodiment of the present invention, θ_{Cm} is maintained at 87 mechanical degrees or 174 electrical degrees. Therefore, 87 mechanical degrees or 174 electrical degrees is the second angle corresponding to an angle through which the rotor rotates without causing a change in the polarity of the existing reluctance torque between the stator and the rotor. A third angle, corresponding to the difference between the first and the second angle, is calculated. Therefore, 45 mechanical degrees of the 87 mechanical degrees are used for torque generation and for the rest of the 42 mechanical degrees the phase is free wheeled. For 84 electrical degrees between the alignment position of the rotor at the end of commutation for counterclockwise rotation and the fully aligned position of rotor, the slope of the inductance does not change polarity. Therefore, the phase behaves as if it is in a current regulation mode and, by virtue of the energy stored in the phase delivers a positive torque instead of negative torque as in a conventional SR machine.

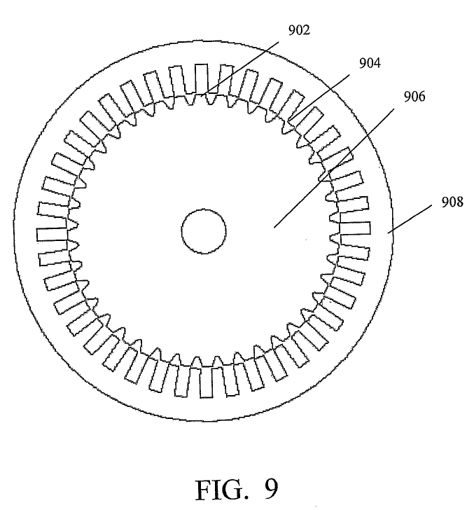

A phase is energized when the rotor poles 902 corresponding to that phase have reached the angular position with respect to stator poles 904, which is the start of commutation for counter clockwise motion, as illustrated in FIG. 9.

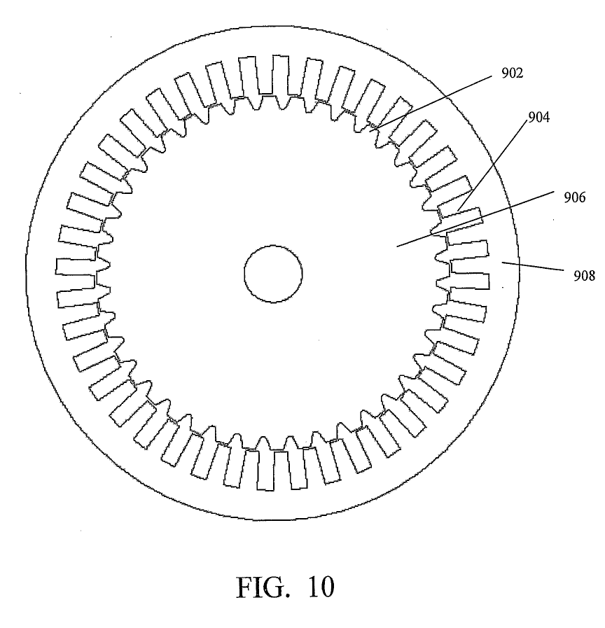

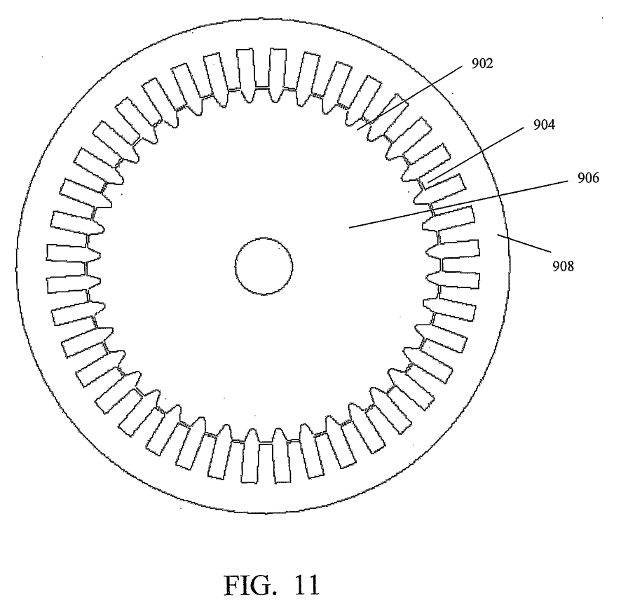

FIG. 10 illustrates an alignment of a rotor poles 902 and stator poles 904 at the end of commutation for counterclockwise rotation of the rotor 906, in accordance with one embodiment of the present invention. Therefore, after the rotor 906 rotates through an angle of commutation from the position illustrated in FIG. 9 it attains the position as illustrated in FIG. 10. The energized phase is switched off and is freewheeled while the rotor 906 rotates from the position illustrated in FIG. 10 to the position illustrated in FIG. 11. FIG. 11 illustrates a fully aligned position of rotor 906 and stator 908 of an S SRM, in accordance with one embodiment of the present invention.

The energy stored in the phase is completely dissipated when the rotor reaches the fully aligned position as illustrated in FIG. 11. Therefore, in the S SRM of the present invention, during the period when the phase has been turned off for current regulation, a positive torque (T) is generated. Based on the o that is prevailing at that instant of time Tω is the transient conversion of energy from the electrical form into the mechanical form and this energy is derived from the energy stored in the phase. Hence this energy and, also the ever-present copper loss act as a drain on the energy that has been stored in the phase. Consequently, the current in the phase drops and the phase gets turned on again for current regulation.

Therefore, in the S SRM of the present invention, no active methods are required for draining the energy from the phase that is being turned off and for using it to pump the phase that is being turned on. Since, in the S SRM the rise of current in the phase being turned on and the fall of current in the phase that is being turned off is mirrored, the sum of the squares of the current is approximately constant. Hence, the sum of the torques being generated is also proportionately constant.

The S SRM may be designed and operated as a generator by making suitable modifications to the embodiment described herein. For a clockwise rotation, a supervisory control system ensures that when the rotor and stator corresponding to a phase reach the fully aligned position as indicated in FIG. 11, the maximum current set by the supervisory control system is established in that phase. Energizing of the phase is stopped once the fully aligned position as indicated in FIG. 11 is reached. Electromotive force (EMF) is generated when the rotor and stator corresponding to the phase move from the fully aligned position to the unaligned position. The region between the position as indicated in FIG. 11 to the position as indicated in FIG. 10 is a generation region of the phase, for a clockwise rotation of the rotor. This sequence of energizing the phase before reaching the fully aligned position and using the second angle of motion to generate electricity is repeated continuously, based on a sensor input of the angular position.

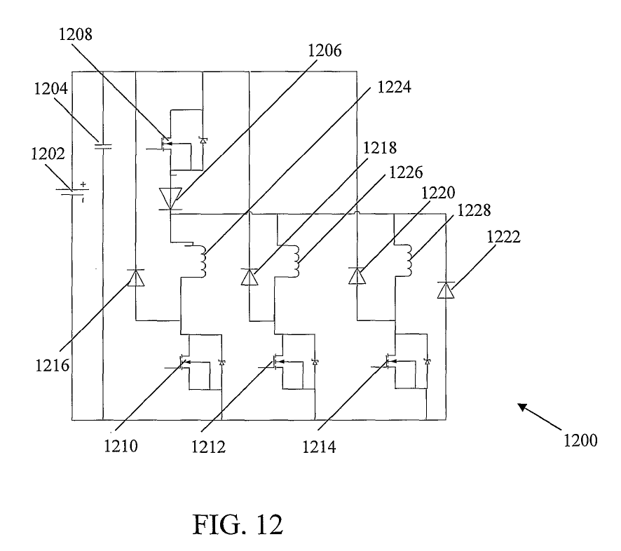

FIG. 12 illustrates a control circuit 1200 for a three phase S SRM being operated as a generator, in accordance with one embodiment of the present invention. The control circuit 1200 is powered by input power supply 1202 which may be a battery. The control circuit 1200 comprises a filter capacitor 1204, a diode 1206 for enabling unidirectional current flow, a top side switch 1208, bottom side switches 1210, 1212 and 1214 and, diodes 1216, 1218, 1220 and 1222. In an embodiment, the top side switch 1208 is a common MOSFET or IGBT which is used to connect any of phases 1224, 1226 and 1228 to the input power supply 1202. In an embodiment of the present invention, the phases 1224, 1226 and 1228 are energized in a current regulated manner by using hysteresis regulation or PWM, with the help of either boot-strap or charge pump circuits. The bottom side switches 1210, 1212 and 1214 are used to turn the phases 1224, 1226 and 1228 on or off. The diodes 1216, 1218 and 1220 are protective diodes for the phases 1224, 1226 and 1228 respectively, and the diode 1222 is a common protective diode. When both the top side switch 1208 and the bottom side switches 1210, 1212 and 1214 are turned off, a freewheeling path is created through the input power supply 1202. Consequently, a freewheeling current charges the input power supply 1202, thereby quickening draining of an off-going phase, by the rate at which energy is being dumped into the input power supply 1202. This mechanism of dumping energy into the input power supply 1202 causes the S SRM to run as a generator.

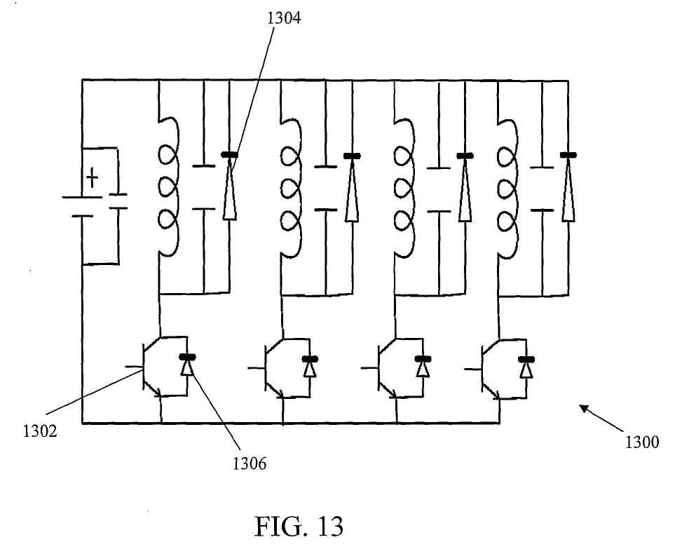

FIG. 13 illustrates a control circuit 1300 for a four phase S SRM, in accordance with one embodiment of the present invention. The operation of the machine is controlled by the control circuit 1300, which comprises one switch 1302 per phase of the S SRM, a freewheeling diode 1304 for each phase and a diode 1306 to protect the switch 1302 in each phase, during a motor mode operation of the S SRM. The switch 1302 is positioned on a low side of the control circuit 1300.

The freewheeling diode 1304 freewheels a phase that is being de-energized. The freewheeling commences after the rotor rotates through an angle corresponding to a minimum commutation requirement while delivering positive torque.

A phase in the S SRM is energized in a current regulated manner. In an embodiment of the present invention, the phase is energized in a current regulated manner by using hysteresis regulation or PWM. Switch 1302 positioned on the low side of the control circuit 1300 performs the required current regulation. Therefore, a dedicated switch for performing the current regulation is not required in the S SRM, described in the present invention.

Therefore, in the S SRM described herein, the control circuit is of a one switch per phase configuration, thereby making the control circuit simpler. Further, the switch is positioned on the low side of the control circuit, thereby eliminating the high side drive problem of the IGBT or the MOSFET. By virtue of this feature, a simple freewheeling diode with a snubber capacitor is sufficient for meeting the control requirements of the S SRM. In addition, since, the single switch per phase positioned on the low side of the control circuit performs both the current regulation switching as well as the commutation switching, the number of components that are used in the S SRM are reduced. Elimination of the topside side switch results in one less device drop, thereby improving the efficiency of the S SRM. Therefore, the control circuit of the S SRM described herein is simple, efficient, reliable and provides a distinct cost advantage.

The S SRM is designed to support a higher angle of commutation than is necessary and generates a positive torque by freewheeling the phase through the angle of motion in excess of the required commutation angle. Therefore, the S SRM provides the advantage of, elimination of negative torque generated by an off going phase. Further, in the S SRM a productive use of the energy of the off going phase is made by freewheeling the phase. This leads to the advantage of a reduction in the torque ripple of the SRM. These distinct advantages are obtained with no addition of active control variables.

In addition, in the S SRM, increasing the number of poles helps in multiplying the torque without reducing the coil winding space. This leads to the derivation of high torque densities from the S SRM. Further, by manipulating the coil winding of the phases, high power densities may also be derived from the S SRM.

While the present invention has been shown and described with reference to preferred embodiments, it will be understood by those skilled in the art that various changes in form and detail may be made therein without departing from or offending the spirit and scope of the invention as defined by the appended claims.

I claim:

1. A switched reluctance (SR) machine supporting a plurality of phases distributed along an axis of rotation, each phase whereof comprising a hollow and substantially cylindrical stator having a plurality of inwardly extending stator poles positioned substantially equidistant from each other, two adjacent stator poles defining a recess therebetween; a substantially cylindrical rotor positioned in the stator and having a plurality of outwardly extending rotor poles formed on the outer surface thereof, each of the stator pole and the rotor pole subtending an angle having a value less than 0.5 electrical pole pitches at a center of rotation; a means for supporting the rotor for rotation about the axis; coils provided on stator poles in proportion to the number of the poles wound thereon and occupying the recess between adjacent stator poles; the rotor being rotated in a desired direction of motion by a reluctance torque generated between the rotor and the stator, the reluctance torque being generated by energizing a phase in a current controlled manner, the energizing concluding upon the rotation of the rotor through a minimum commutation angle required to maintain motion, de-energizing the phase by freewheeling the phase, a freewheeling current being maintained by energy stored in the phase, and energizing a second sequential phase, the steps of de-energizing the phase and energizing a second sequentially adjacent phase being performed substantially simultaneously.

2. A switched reluctance (SR) machine supporting a phase comprising a hollow and substantially cylindrical stator having a plurality of inwardly extending stator poles positioned substantially equidistant from each other, two adjacent stator poles defining a recess therebetween; a substantially cylindrical rotor positioned in the stator and having a plurality of outwardly extending rotor poles formed on the outer surface thereof, each of the stator pole and the rotor pole subtending an angle having a value less than 0.5 electrical pole pitches at a center of rotation; a means for supporting the rotor for rotation about the axis; coils provided on stator poles in proportion to the number of the poles wound thereon and occupying the recess between adjacent stator poles; the rotor being rotated in a desired direction of motion by a reluctance torque generated between the rotor and the stator, the reluctance torque being generated by energizing the phase in a current controlled manner, the energizing concluding upon the rotation of the rotor through a minimum commutation angle required to maintain motion, de-energizing the phase by freewheeling the phase, a freewheeling current being maintained by energy stored in the phase.

3. A switched reluctance (SR) machine supporting one or more phases distributed along the axis of rotation, each phase whereof comprising a hollow and substantially cylindrical rotor having a plurality of inwardly extending rotor poles positioned substantially equidistant from each other, a substantially cylindrical stator positioned in the rotor and having a plurality of outwardly extending stator poles formed on the outer surface thereof, two adjacent stator poles defining a recess therebetween, each of the stator pole and the rotor pole subtending an angle having a value less than 0.5 electrical pole pitches at the center of rotation; a means for supporting the rotor for rotation about the axis; coils provided on stator poles in proportion to the number of poles, wound thereon and occupying the recess between adjacent stator poles; the rotor being rotated in a desired direction of motion by a reluctance torque generated between the rotor and the stator, the reluctance torque being generated by energizing a phase in a current controlled manner, the energizing concluding upon the rotation of the rotor through a minimum commutation angle required to maintain motion, de-energizing the phase by freewheeling the phase, a freewheeling current being maintained by energy stored in the phase, and energizing a second sequential phase, the steps of de-energizing the phase and energizing a second sequentially adjacent phase being performed substantially simultaneously.

4. A switched reluctance (SR) machine supporting a phase comprising a hollow and substantially cylindrical rotor having a plurality of inwardly extending rotor poles positioned substantially equidistant from each other, a substantially cylindrical stator positioned in the rotor and having a plurality of outwardly extending stator poles formed on the outer surface thereof, two adjacent stator poles defining a recess therebetween, each of the stator pole and the rotor pole subtending an angle having a value less than 0.5 electrical pole pitches at the center of rotation; a means for supporting the rotor for rotation about the axis; coils provided on stator poles in proportion to the number of poles, wound thereon and occupying the recess between adjacent stator poles; the rotor being rotated in a desired direction of motion by a reluctance torque generated between the rotor and the stator, the reluctance torque being generated by energizing the phase in a current controlled manner, the energizing concluding upon the rotation of the rotor through a minimum commutation angle required to maintain motion, de-energizing the phase by freewheeling the phase, a freewheeling current being maintained by energy stored in the phase.

5. The SR machine as claimed in claim 1, 2, 3 or 4 wherein number of coils corresponding to a phase being either equal to or half the number of stator poles.

6. The SR machine as claimed in claim 1, 2, 3 or 4 wherein the SR machine is a motor or a generator.

7. The SR machine as claimed in claim 1, 2, 3 or 4 wherein a position for commutation is sensed using one of optical sensors, inductive sensors, capacitive sensors, hall effect sensors or by using sensor-less methods.

8. The SR machine as claimed in claim 1, 2, 3 or 4 comprising a control circuit for controlling the operation of the machine, the control circuit comprising one switch per phase of the machine, the switch being positioned on a low side of the control circuit in a motor mode.

9. The SR machine as claimed in claim 8 wherein a phase is energized in a current regulated manner by using hysteresis regulation, the regulation being performed by the switch being positioned on the low side of the control circuit.

10. The SR machine as claimed in claim 8 wherein a phase is energized in a current regulated manner by using hysteresis regulation of the topside switch and the commutation switching is carried out by the low side switch of the control circuit.

11. The SR machine as claimed in claim 8 wherein the control circuit further comprises a freewheeling diode for freewheeling a phase that is being de-energized, the freewheeling commencing after the rotor rotates through a minimum commutation angle required to maintain motion.

12. A method of operating a switched reluctance (SR) machine supporting one or more phases distributed along the axis of rotation, each phase whereof comprising a hollow and substantially cylindrical stator having a plurality of inwardly extending stator poles positioned substantially equidistant from each other, two adjacent stator poles defining a recess therebetween; a substantially cylindrical rotor positioned in the stator and having a plurality of outwardly extending rotor poles formed on the outer surface thereof, each of the stator pole and the rotor pole subtending an angle having a value less than 0.5 electrical pole pitches at the center of rotation; a means for supporting the rotor for rotation about the axis; coils provided on stator poles in proportion to the number of the poles and wound thereon, the coils occupying the recess between adjacent stator poles; the method comprising the step of:
rotating the rotor in a desired direction of motion by a reluctance torque generated between the rotor and the stator, the reluctance torque being generated by continuously and repeatedly performing the steps of:
energizing a first phase in a current controlled manner for a first period of time, the first period of time being a time in which the rotor rotates through a minimum commutation angle required to maintain motion;
de-energizing the phase by freewheeling the phase, a freewheeling current being maintained by energy stored in the phase;
energizing a second sequential phase;
the steps of de-energizing the phase and energizing a second sequential adjacent phase being performed substantially simultaneously.

13. A method of operating the SR machine as claimed in claim 12 comprising:
calculating a first angle, the first angle corresponding to a minimum commutation angle required to maintain motion;
calculating a second angle, the second angle corresponding to an angle through which the rotor rotates without causing a change in a polarity of the existing reluctance torque between the stator and the rotor, the second angle being greater than the first angle;
calculating a third angle, the third angle corresponding to the difference between the first and the second angle;
energizing a phase in a current controlled manner, the energizing concluding upon the rotation of the rotor through the first angle;
de-energizing the phase by freewheeling the phase while the rotor rotates through the third angle, a freewheeling current being maintained by energy stored in the phase; and
energizing a second sequential phase, the steps of de-energizing the phase and energizing the second sequential phase being performed substantially simultaneously.

14. A method of operating the SR machine as claimed in claim 13 wherein the machine is operated as a motor.

15. A method of operating the SR machine as claimed in claim 13 wherein the machine is operated as a generator.
